(19) United States
(12) Patent Application Publication
(10) Pub. No.: US 2015/0091523 A1
(43) Pub. Date: Apr. 2, 2015

(54) WIRELESS CHARGER SYSTEM THAT HAS VARIABLE POWER / ADAPTIVE LOAD MODULATION

(71) Applicant: MediaTek Singapore Pte. Ltd., Singapore (SG)

(72) Inventors: Anand Satyamoorthy, Somerville, MA (US); Patrick Stanley Riehl, Cambridge, MA (US); William Plumb, Charlestown, MA (US)

(21) Appl. No.: 14/503,326

(22) Filed: Sep. 30, 2014

Related U.S. Application Data
(60) Provisional application No. 61/885,606, filed on Oct. 2, 2013.

(51) Int. Cl. H02J 7/02; H02J 7/00

(52) U.S. Cl. CPC H02J 7/025; H02J 7/0052
USPC 320/108; 320/137

(57) ABSTRACT

A wireless charging system that includes in-band communication includes: a source device, including: at least a transmitter coil for providing a wireless charging power which is modulated according to a reflected impedance of at least a target device; and at least the target device, oriented on and magnetically coupled to the source device, for receiving the charging power. The target device includes: a receiver coil, loosely coupled to the transmitter coil, for receiving the charging power; a variable resistor loading the receiver coil; and a power detection and modulation circuit, for determining a size of the charging power, and providing a modulation control signal to the variable resistor according to the size of the charging power, for varying the resistance of the variable resistor in order to control an impedance of the target device which will be reflected at the source device.

### CROSS REFERENCE TO RELATED APPLICATIONS

This application claims the benefit of U.S. Provisional Application No. 61/885,606, filed on Oct. 2, 2013, the contents of which are included entirely herein by reference.

### BACKGROUND

Portable electronic devices, such as smartphones and tablets, are ubiquitous in everyday life. 3G technology means these portable electronic devices can provide a user with Internet connectivity, as well as providing other functions such as GPS, video and camera imaging, and standard telecommunications services. The high number of applications available on an average smartphone will inevitably consume a large amount of power . Many users therefore carry a dedicated charger with them, to prevent a low power situation due to high use.

As well as stored battery chargers and standard wired chargers that couple directly from a power point to an electronic device by means of a cable or USB, wireless chargers have also been developed. Wireless chargers can employ wireless technology such as Bluetooth, Wi-Fi, and ZigBee to carry out wireless charging of an electronic device.

Two current wireless charging systems are Wireless Power Consortium's (WPC) Qi and Power Matters Alliance (PMA). Both these methods use inductive technology and asynchronous serial communication, i.e. where the transmitter and receiver do not have to be exactly synchronized at all times so that no bit synchronization signal is required. A standard charging device employing one of these technologies is known as a Source Device (SD), and consists of a pad which acts as a charger. A device to be charged is known as a Target Device (TD).

Both the above technologies require that the TD be flush with the SD, i.e. that there is close contact. Further, there are only a limited number of ways in which the TD can be oriented on the SD, due to the simple asynchronous communication scheme. The resultant charging setup has the TD and SD tightly coupled. This high coupling factor means that the signal-to-noise ratio is also high. The advantage of this system is that wireless charging can be performed on a portable electronic device with only a simple scheme. The high SNR means there is little background noise, allowing the use of asynchronous serial communication.

If a user commonly carries more than one portable electronic device, however, they will require a separate dedicated charger (SD) for each electronic device (TD). Further, the required close contact and particular orientation for the inductive charging schemes means that wireless charging is limited to situations where the user is stationary. In a situation where the user is moving, such as when travelling on a train or bus, the inductive charging scheme is quite ineffective.

In light of the above, a different type of wireless charger called Resonant Wireless Power (RWP) has been developed. An RWP charging system also has a Source Device (SD) but may have more than one TD, wherein the TDs can be loosely coupled to the SD. Further, the precise orientation required by the above schemes is not necessary for the RWP system.

The loose coupling, however, results in a low SNR, which means that asynchronous serial communication is not possible. There is therefore a need for an RWP charging system that can charge multiple target devices while meeting the standards of message detection, reliable message decoding, and synchronization.

### SUMMARY

A wireless charging system for enabling bi-directional communication comprises: a source device, comprising: a transmitter coil for providing a wireless charging power which is modulated according to a reflected impedance of at least a target device; and at least the target device, oriented on and magnetically coupled to the source device, for receiving the charging power. The target device comprises: a receiver coil, loosely coupled to the transmitter coil, for receiving the charging power; a variable resistor coupled across the receiver coil; and a power detection and modulation circuit, for determining a size of the charging power, and providing a modulation control signal to the variable resistor according to the size of the charging power, for varying the resistance of the variable resistor in order to control an impedance of the target device which will be reflected at the source device.

A method for providing bi-directional communication in a wireless charging system comprises: orienting at least a target device to be in proximity to a source device; driving a transmitter coil in the source device to provide a wireless charging power which is modulated according to a reflected impedance of at least the target device; providing a receiver coil in the target device to receive the charging power; determining a size of the charging power; generating a modulation control signal according to the size of the charging power; and varying a resistance of a variable resistor coupled across the receiver coil to control an impedance of the target device which will be reflected at the source device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A illustrates a receiver circuit of a conventional target device.

FIG. 1B illustrates another receiver circuit of a conventional target device.

FIG. 2 is a diagram of a receiver modulation circuit according to an exemplary embodiment.

FIG. 3A is a diagram of a first configuration of the variable resistor shown in FIG. 2.

FIG. 3B is a diagram of a second configuration of the variable resistor shown in FIG. 2.

FIG. 4 is a block diagram of a transmitter communication path.

FIG. 5 is a block diagram of a receiver communication path for a non-dispersive channel.

FIG. 6 is a block diagram of a receiver communication path for a dispersive channel.

### DETAILED DESCRIPTION

The disclosure therefore proposes an RWP charging system that utilizes a variable load modulation scheme.

In an RWP charging system, it is important for there to at least be communication from the TD to the SD. Communications can be in-band, i.e. on the same dedicated carriers as those used for power charging, or out-of-band, i.e. using wireless communication methods such as Bluetooth or Wi-Fi. The in-band solution is less complex and also offers a lower cost. One means of in-band communication between the TD and SD is to vary impedance at the TD which will be seen by the SD, i.e. reflected impedance. An inductor such as a coil in the SD is driven by an amplifier which also drives the reflected impedance to deliver power to the TD. Therefore, any change in reflected impedance seen at the SD will cause the power waveforms from the SD to vary accordingly. This technique is called load modulation, and can be performed by placing a resistive element such as a resistor or a capacitor in parallel with an inductor in the TD.

As mentioned in the background, an RWP charging system can simultaneously charge more than one TD. Therefore, it is not only necessary for the SD to detect when a single TD is coupled to the system, but the SD must also be able to detect multiple TDs and power each accordingly. Further, the SD must control charging of each TD so none enter a state of over-charging. The RWP charging system can operate in at least four different modes: standby (when no TD is detected); power transfer; charge complete; and fault. This last mode can provide voltage protection, and prevent the TDs from being overheated. The SD should also recognize when an unauthorized object is placed on the SD, so the SD does not erroneously provide power to an object that should not be charged.

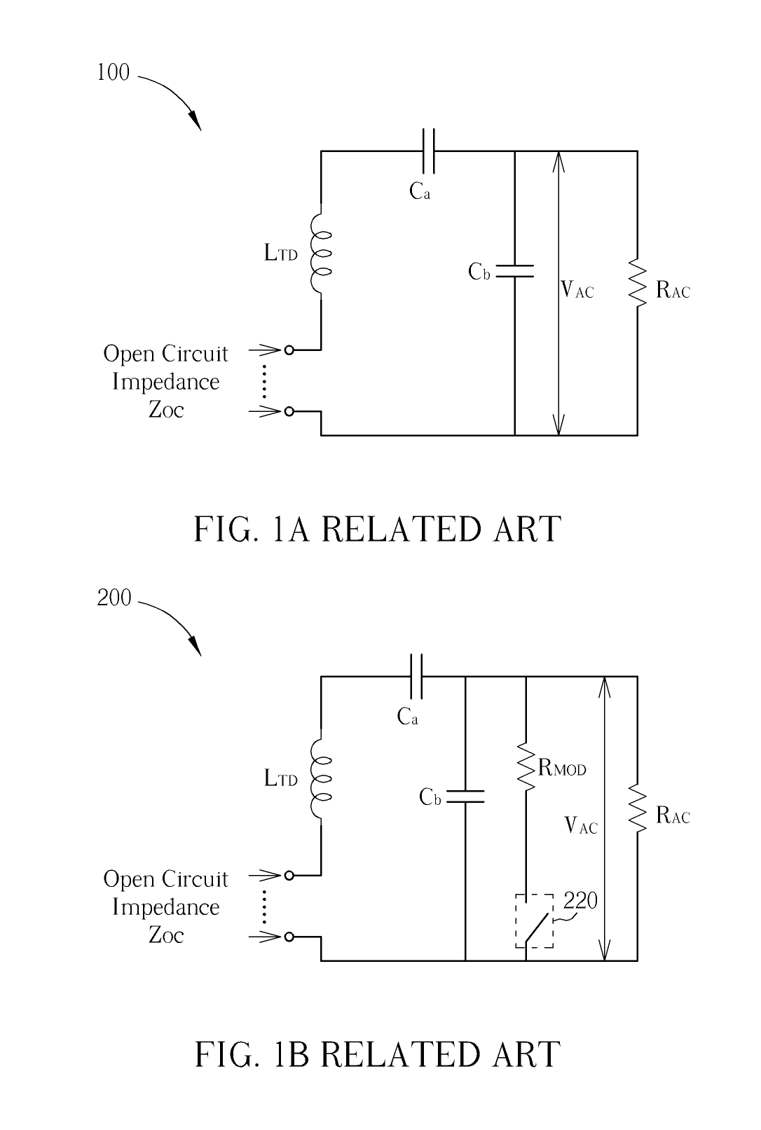

The following will detail the basic processes of load modulation more clearly, and then describe a proposed variable modulation scheme. FIG. 1A illustrates a receiver circuit 100 of a TD. The circuit 100 comprises an inductor (coil) L_{TD}, a first capacitor Ca, a second capacitor Cb, and a resistor R_{AC}. An open impedance of the circuit is Z_{OC}. R_{AC} represents the effective power delivered to the output, which is given by equation (1):

$${P}_{AC} = \frac{VAC 2 RMS}{RAC}$$

The reflected impedance can be given by the following equations (2) and (3):

$${Z}_{ref} = \frac{( ω M ) 2}{ZOC}$$

$$M = k \sqrt{LSD * LTD}$$

where M is the mutual inductance, i.e. inductance of the TD coil and of the SD coil (not shown), and k is the coupling factor between the two coils.

The power provided to the source amplifier is a function of both the amplifier and the coil to coil efficiency, which depends on the coupling factor. The power in is given by equation (4):

$${P}_{IN} = \frac{PAC}{η AMP * η Coil to Coil}$$

From equation (1), this can be rewritten as equation (5):

$${P}_{IN} = \frac{VAC 2 RMS}{RAC * η AMP * η Coil to Coil}$$

As shown by the above, the power provided from the SD to the TD is a function of efficiency.

FIG. 1B is a circuit 200 which contains the same components as those in the circuit 100 but also includes a dissipative element R_{MOD}, which can be coupled to the circuit 200 or removed by use of the switch 220. In a phase φ1 where R_{MOD} is removed, the input power is given by equation (5). In a phase φ2 where R_{MOD} is inserted, the power in is given by equation (6):

$${P}_{IN} = \frac{VAC 2 RMS * ( RAC + R MOD )}{RAC * R MOD η AMP * η Coil to Coil}$$

As shown by the above, and assuming that R_{AC} represents a constant power load (due to a DC-DC converter—not shown—in the TD), the addition of R_{MOD} will increase the input power because the same voltage will be present across R_{MOD} as across R_{AC}. The difference in power between the two phases is called the modulation power P_{MOD}. Note that the modulation power P_{MOD} is proportional to the square of V_{AC}. The AC voltage V_{AC}RMS can vary by a factor of 2 or more in a practical wireless power system, which in turn implies that the modulation power can vary by a factor of 4 or more for the same R_{MOD}. Note that it is also possible to detect modulation by monitoring AC terminal voltage or current. The following will use modulation power as an exemplary embodiment.

As the proposed RWP charging system can charge many different TDs, it is important that the modulation power can be controlled. The modulation power must be large enough for the SD to detect, but not large enough to cut off power delivery. Keeping the modulation power within an acceptable range is made more difficult by the dependence on the square of the RMS input voltage. The present invention therefore proposes a variable modulation scheme.

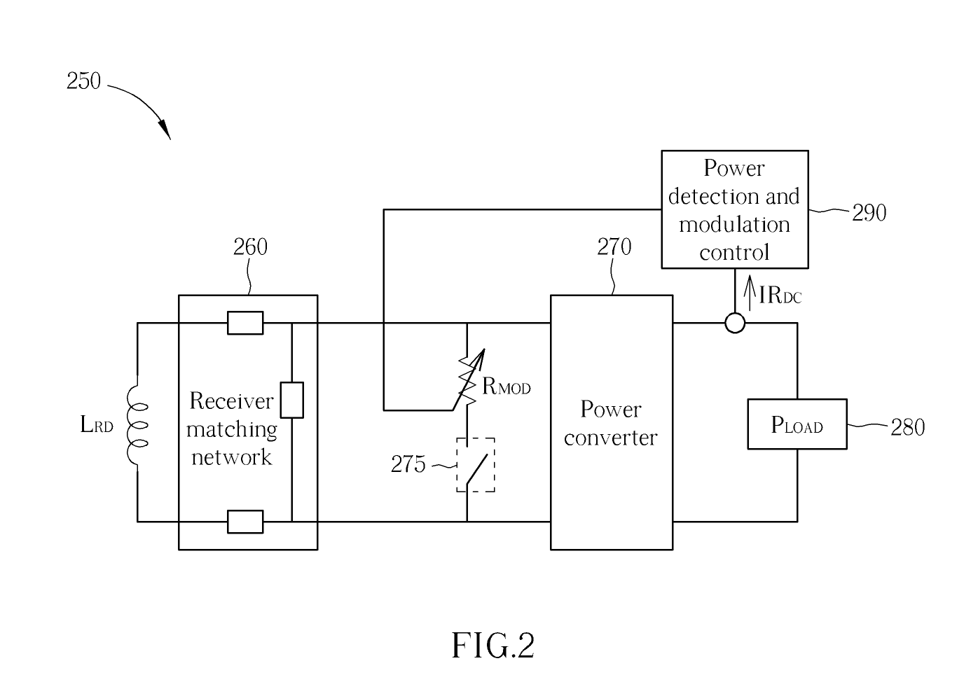

FIG. 2 is a diagram of a receiver modulation circuit 250, wherein circuit 250 is within the TD. Circuit 250 comprises an inductor coil L_{RD} coupled across a receiver matching network 260, and a power converter 270. A detection circuit P_{LOAD} 280 is coupled across the power converter 270 to detect power IR_{DC}. The detection circuit may first filter the power detected in order to remove any background noise. The variable modulation resistor R_{MOD} is coupled across the receiver and can be selectively added to or removed from the circuit by means of the switch 275. The power detected by the detection circuit 280 is supplied to power detection and modulation control circuit 290, which detects voltage supplied to and current consumed by the load, and provides a signal to the modulation resistor R_{MOD}.

By means of this feedback signal, R_{MOD} can be controlled in a variety of ways to affect the modulation power. The modulation power can be held constant regardless of the load power, for cases where there is a danger of exceeding safe power limits. The modulation power can vary inversely or in proportion to variation in load power. The modulation power may also be increased or reduced based on internal or external signals; for example, due to a request from the SD.

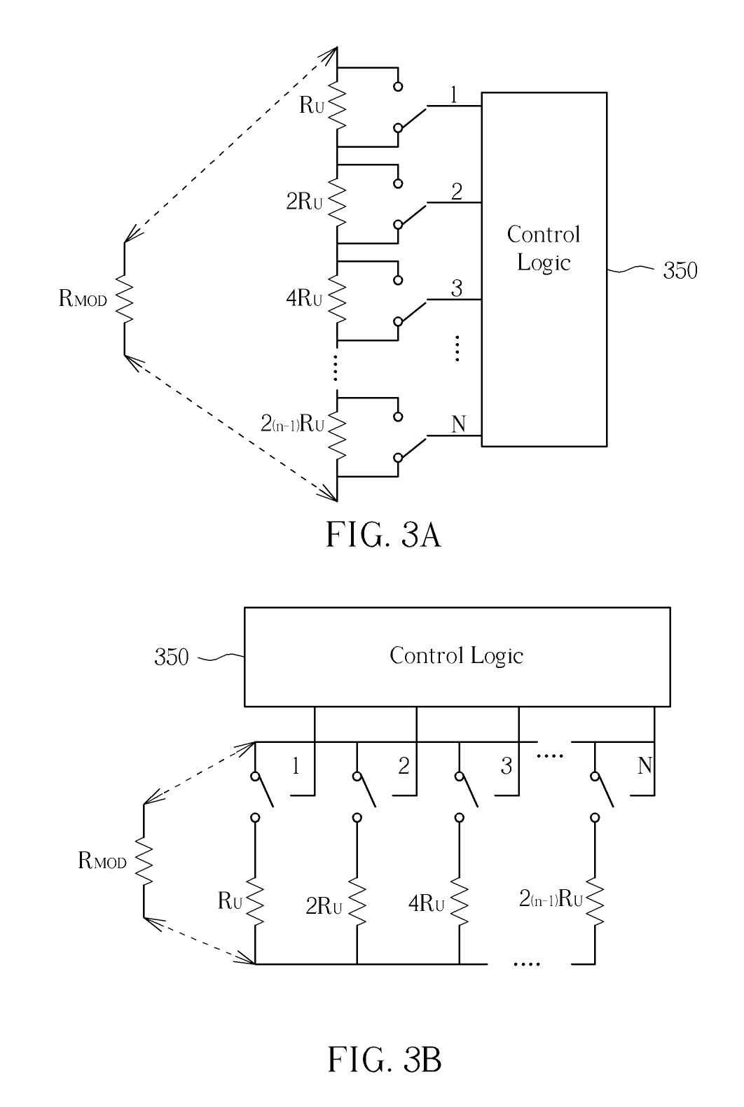

The modulation resistor is formed of a plurality of resistors, which can be coupled in a number of configurations to vary the resistance thereof. FIG. 3A is a diagram of a first configuration of the variable resistor R_{MOD}. In FIG. 3A, the variable resistor is formed of a plurality of resistors coupled in series, which are respectively controlled by a control logic 350. The plurality of resistors can be of different sizes; in FIG. 3A, they are binary weighted. The variable resistor may also be formed of a plurality of resistors coupled in parallel, as illustrated in FIG. 3B. These parallel resistors are also controlled by the control logic 350 and are binary weighted, but are not limited thereto. The variable resistor may also be an R-2R configuration, or may be any of the above three schemes also comprising at least a fixed resistor.

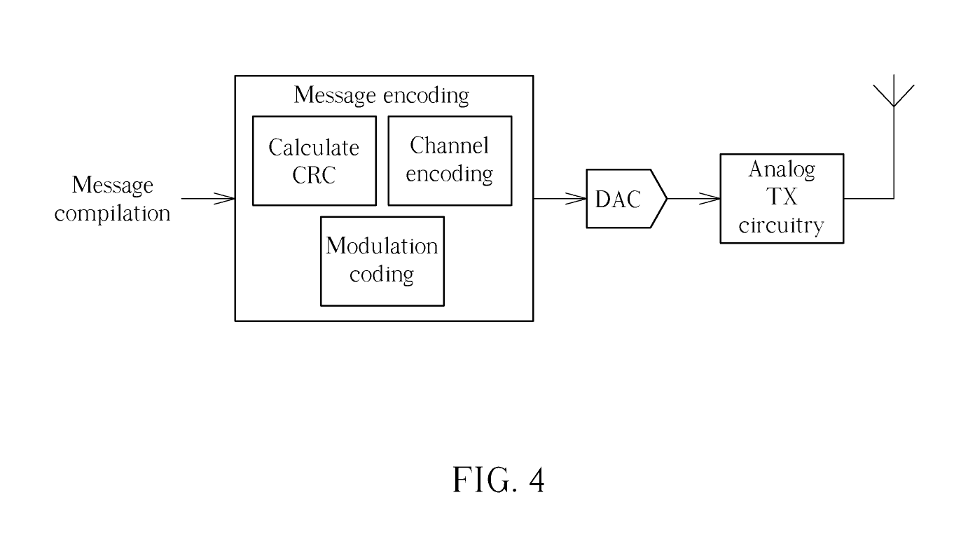

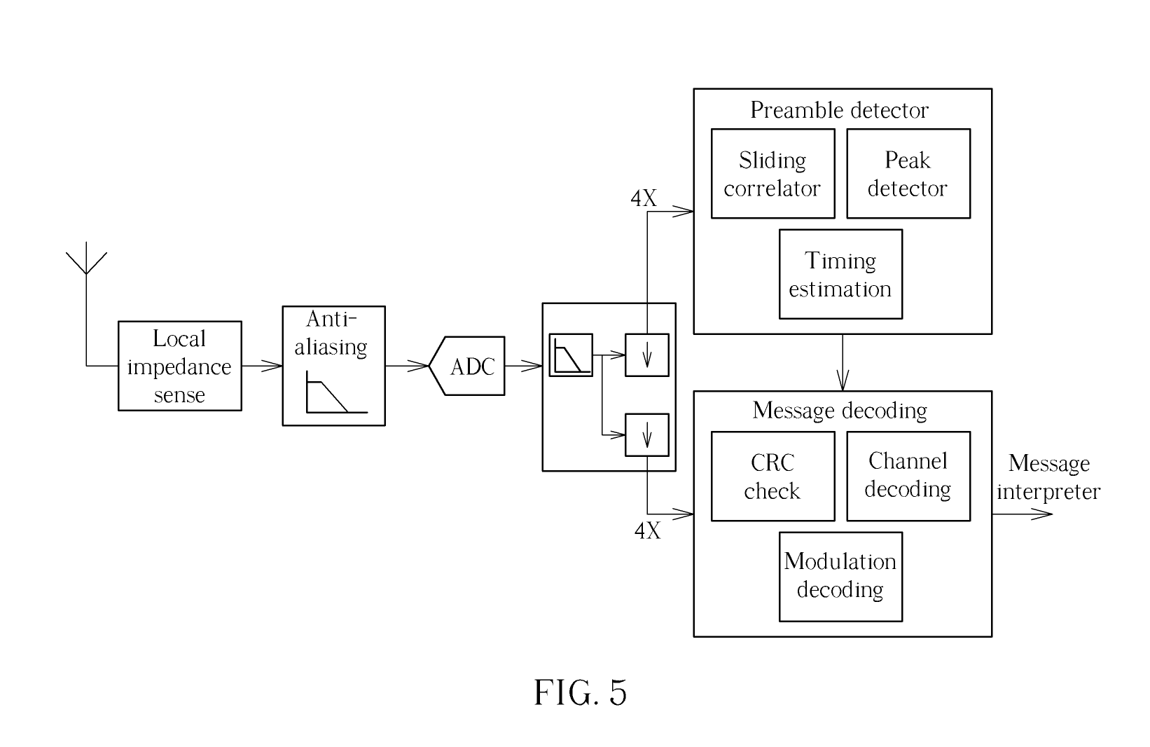

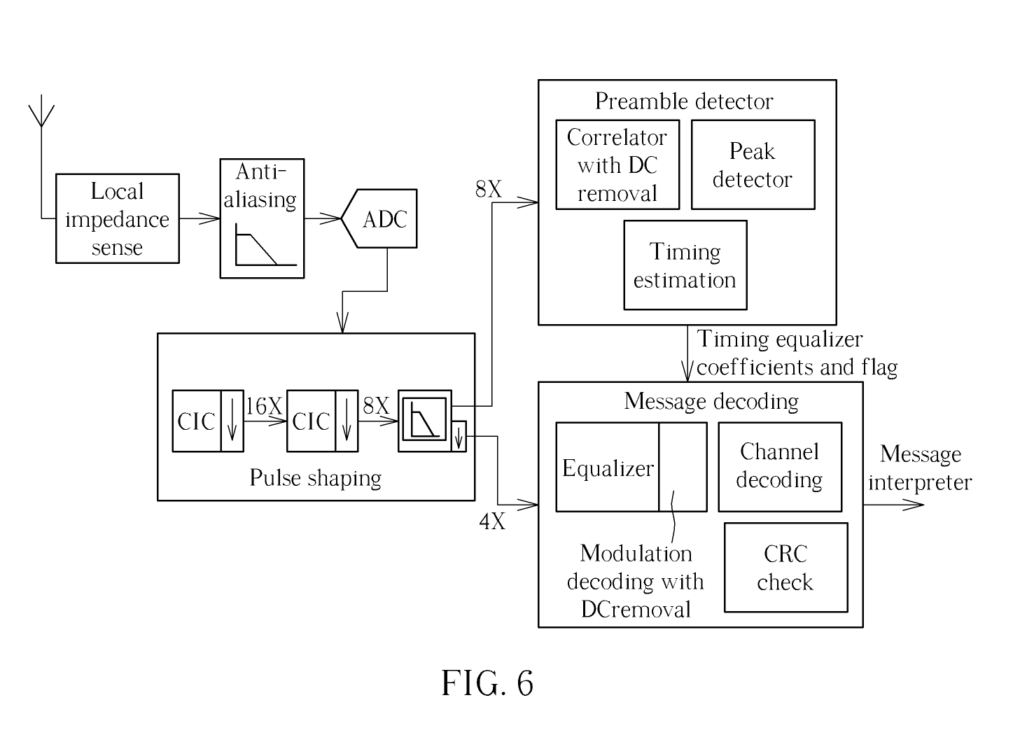

The low SNR involved with RWP charging means that message detection and decoding can be challenging. The RWP charging system therefore incorporates CRC calculation, attaches a preamble to messages, performs modulation on signals, and also provides an active switching element for varying the impedance. Messages are synchronized, then demodulated, and a final CRC is performed to check the validity. FIGS. 4˜6 illustrate, respectively, a block diagram of a transmitter communication path, a block diagram of a receiver communication path for a non-dispersive channel, and a block diagram of a receiver communication path for a dispersive channel. These steps of adding CRC, decoding etc. are well-known in the art and will not be further detailed herein.

The size of the message will affect the time interval in which messages can be transmitted. If, for example, a data message has 8 bits, the total message will be 15 bits of data. After the CRC and preamble are added, as well as the modulation, the total size of the message will be 107 bits. As more than one TD can be charged in the RWP charging system, there maybe message collision. The RWP charging system can provide a back-up scheme, wherein an unsent message is retried in a next transmission opportunity.

In the RWP charging system, resistor R_{MOD} is much larger than R_{AC} in order to limit the extra power expended for the purpose of communications. Further, the above arrangements are merely provided as exemplary examples, rather than limitations. As standards in the industry improve, SD detection will also improve. It is noted that the RWP charging system is a closed system, so the SD and TDs must be authorized devices that can be coupled in the system. As R_{MOD} will only alter the reflected impedance seen at the SD, there are no crosstalk issues.

The above disclosure therefore provides a wireless charging scheme that can utilize in-band communication between a plurality of target devices and a source device, by means of variable resistive modulation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless charging system that includes in-band communication, comprising:
a source device, comprising:
at least one transmitter coil for providing a wireless charging power; and
at least the target device, oriented on and magnetically coupled to the source device, for receiving the charging power, the target device comprising:
a receiver coil, loosely coupled to the transmitter coil, for receiving the charging power; and
a variable resistor loading the receiver coil.

2. The wireless charging system of claim 1, wherein the target device further comprises a power detection and modulation circuit, for determining a size of the charging power, and providing a modulation control signal to the variable resistor according to the size of the charging power, for varying the resistance of the variable resistor in order to control an impedance of the target device which will be reflected at the source device.

3. The wireless charging system of claim 2, wherein the variable resistor comprises a plurality of weighted resistors respectively controlled by a plurality of control logic signals.

4. The wireless charging system of claim 3, further comprising at least a fixed resistor.

5. The wireless charging system of claim 3, wherein the plurality of resistors is binary weighted.

6. The wireless charging system of claim 1, wherein the target device can be arbitrarily oriented on the source device.

7. The wireless charging system of claim 2, wherein the source device can determine the presence or absence of a target device according to the reflected impedance.

8. The wireless charging system of claim 2, wherein the source device can determine the presence of a foreign object according to the reflected impedance.

9. The wireless charging system of claim 2, wherein the source device can enter a plurality of different modes according to the reflected impedance.

10. The wireless charging system of claim 9, wherein the plurality of modes comprise standby, power transfer, charging complete, and fault.

11. The wireless charging system of claim 2, wherein the resistance of the variable resistor is varied in order to keep the modulation power constant.

12. The wireless charging system of claim 2, wherein the resistance of the variable resistor is varied in order to keep the modulation power proportional to the charging power.

13. The wireless charging system of claim 2, wherein the resistance of the variable resistor is varied in accordance with a request from the source device.

14. A method that includes in-band communication in a wireless charging system, the method comprising:
orienting at least a target device to be in proximity to a source device;
driving at least one transmitter coil in the source device to provide a wireless charging power which is modulated according to a reflected impedance of at least the target device;
providing a receiver coil in the target device to receive the charging power;
determining a size of the charging power; and
generating a modulation control signal according to the size of the charging power.

15. The method of claim 14, further comprising:
varying a resistance of a variable resistor coupled across the receiver coil to control an impedance of the target device which will be reflected at the source device.

16. The method of claim 15, wherein the variable resistor comprises a plurality of resistors respectively controlled by a plurality of control logic signals.

17. The method of claim 16, wherein the variable resistor further comprising at least a fixed resistor.

18. The method of claim 16, wherein the plurality of resistors is binary weighted.

19. The method of claim 14, wherein the step of orienting at least a target device to be in wireless contact with a source device comprises:
arbitrarily orienting the target device on the source device.

20. The method of claim 15, further comprising:
before driving a transmitter coil in the source device to provide a wireless charging power, determining the presence or absence of a target device according to the reflected impedance.

21. The method of claim 20, further comprising:
determining the presence of a foreign object according to the reflected impedance.

22. The method of claim 20, further comprising:
entering a plurality of different modes according to the reflected impedance.

23. The method of claim 22, wherein the plurality of modes comprise standby, power transfer, charging complete, and fault.

24. The method of claim 16, wherein the step of varying a resistance of a variable resistor coupled across the receiver coil comprises:
varying the resistance of the variable resistor in order to keep the modulation power constant.

25. The method of claim 16, wherein the step of varying a resistance of a variable resistor coupled across the receiver coil comprises:
varying in order to keep the modulation power proportional to the charging power.

26. The method of claim 16, wherein the step of varying a resistance of a variable resistor coupled across the receiver coil comprises:
varying the resistance in accordance with a request from the source device.
